(19) United States
(12) Patent Application Publication
(10) Pub. No.: US 2023/0255359 A1
(43) Pub. Date: Aug. 17, 2023

(54) Furniture with a divided, adjustable lying surface where movement of one part of the lying surface, and longitudinal and lateral directions, aids in the natural decompression of the spine of the person lying in a supine position, with the options of forced, lateral movement of the moveable part of the furniture.

(71) Applicants: Peter Wietki, Irvine, CA (US); Gregory Mark Wietki, Irvine, CA (US)

(72) Inventors: Peter Wietki, Irvine, CA (US); Gregory Mark Wietki, Irvine, CA (US)

(21) Appl. No.: 17/670,450

(22) Filed: Feb. 12, 2022

(51) Int. Cl. A47C 20/00

(52) U.S. Cl. CPC A47C 20/00

(57) ABSTRACT

Furniture is formed from a lie surface divided into two sections and placed on a stationary frame elevated over standing surface by its supports. The frame is tilted to the ground by lengths of its supports. The upper section is attached to the frame by adjustment bolts that change elevation of the section in relation to lower section. The lower section is attached to the frame by guiding devices that let the section to move on the frame in linear and lateral directions. Heights's adjustment of upper section let the user to fit the shape of the lying surface to the shape of lumbar section of his body. User seats on lower, movable section of lying surface and rests his head and torso above waist on upper stationary section. Free movement of lower section let the lumbar part of his body to naturally decompress.

### CROSS-REFERENCE TO RELATED APPLICATIONS

Not applicable to this application.

### BACKGROUND OF THE INVENTION

Numerous medical and non-medical mechanical devices are known in the art for stretching the human frame. These mechanical devices employ both motorized and non-motorized movement and employ various methods to accomplish the goal of stretching, flexing, and/or unloading of the human frame.

However, there are no devices which offer decompression of spine with accommodation for spine's lateral disfiguration like spinal stenosis.

The only device to which presented furniture could be remotely compared to is an inversion table which operates by inverting the human body. By choice of angle of tilt of an inversion table, it offers limited control over the amount of force which is applied for stretching of user's body.

The principle behind operation of inversion table is that, by turning the human frame upside down, gravity acting on the human frame in the reverse direction will facilitate the stretching of muscles stabilizing spine, what increases spaces accommodating spine's discs and facet joints, thereby giving the user a temporary sense of comfort and well-being by reliving pressure of disks and facet joints on nerves.

Unfortunately, inversion devices and other fitness-oriented exercise and stretching devices have typically been uncomfortable, cumbersome, and difficult to operate, especially for older users. The main drawback of using inversion table is that, by suspending user upside down, the user's head is at the lowest point of the body what could be dangerous for some. Furthermore, offered stretching devices don't let user to be in full control of force applied for stretching. Uncontrolled stretching of human body cause, that the muscular structures stabilizing spinal column could be stretched beyond their natural length, what could have detrimental effect.

The introduced invention of furniture with adjustable lying surface where movement of one part of lying surface eliminates all the drawbacks of existing stretching devices and additionally accommodates for lateral disfiguration of user's spine.

### BRIEF SUMMARY OF THE INVENTION

The subject of the invention is furniture with adjustable lying surface where movement of one part of the lying surface aids natural decompression of the lumbar part of person's body when the person is lying down on the furniture in supine position.

The furniture, according to the invention, is created from a lie divided into two sections, which are cushions with plywood backings for rigidity, and placed on a stationary, load-bearing frame that is elevated over its standing surface by its supports, where upper section of the lie is stationary, attached to the frame and lower section of the lie is attached to the frame by guiding device that let the section to slid freely along the frame in longitudinal and lateral direction. Additionally, lower, movable section of the lie is equipped with electric motor which moves the section in lateral direction in relation to longitudinal direction of sections movement. The linear and lateral movements of the section are limited by user's set stops.

The rest bench is characterized by the fact that the surface of the stationary load-bearing frame is tilted to the ground what aids movement of lower, movable section of the lie under the weight of pelvic of lying in a supine position user's body. The angle of inclination of the frame is from 1 to 20 degrees.

The lower part of upper, stationary section of the lie is attached to the stationary load-bearing frame with help of bolts with knobs which let to adjust the vertical distance between the surface of the lower part of stationary section of the lie and the surface of the movable section of the lie from 0 to 5 cm (0 to 2 inch), in vertical direction.

Both sections of the divided lie are connected by flexible connecting element which prevent the movable section of the lie to slide down the frame under its own weight and holds both sections adjacent in preparation for use.

The design of the furniture enable user to exactly adjust the shape of the lie to the shape of lumbar section of user's body.

Free longitudinal movements of movable section the furniture let users to decompress lumbar part of their spines without any mechanical forces.

Free lateral movements of movable section the furniture accommodate needs of users with lateral disfiguration of lumbar part of the spine.

Free longitudinal and forced lateral movements of movable section the furniture let users to exercise muscle surrounding lumbar part of the spine without any gravitational pressure.

Moreover, thanks to ease of use, it is possible for physically weak and seriously ill persons to use this device on its own, without involvement of others to operate the device.

The device could be used as common furniture instead of an armchair or sofa.

The essence of the invention is more closely explained in the detail description of the invention.

### BRIEF DESCRIPTION OF THE VIEWS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope regarding other embodiments which the invention is capable of contemplating. Accordingly:

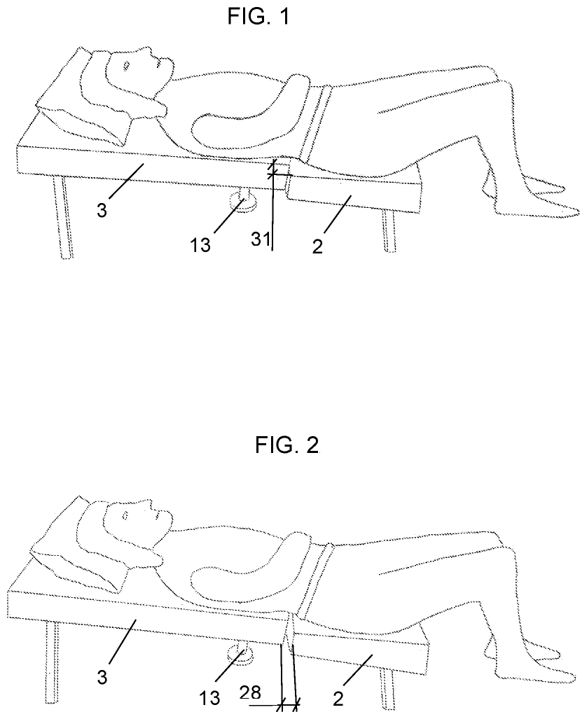

FIG. 1 presents the furniture with divided, adjustable lying surface where linear and lateral movement of one part of lying surface aids natural decompression of the spine of person lying in supine position with the optional, forced, lateral movement of the movable part of the furniture in a user-prepared state for use with user laying on it in supine position. Movable section (2) of lie (1) is adjacent to stationary section (3) of lie (1). The difference in elevation between section (2) of lie (1) and section (3) of lie (1) is created by action of the elevation adjustment bolts with knobs (13) as indicated by (31).

FIG. 2 presents the furniture with divided, adjustable lying surface where linear and lateral movement of one part of lying surface aids natural decompression of the spine of person lying in supine position with the optional, forced, lateral movement of the movable part of the furniture in an in-use state, with user laying on it in supine position and section (2) of lie (1) is disengaged from section (3) of lie (1). The degree of decompression of user's spine is identified by size of the gap (28) between disengaged sections. The difference in elevation between sections (2) of lie (1) and section (3) of lie (1) is created by action of elevation adjustment bolts with knobs (13).

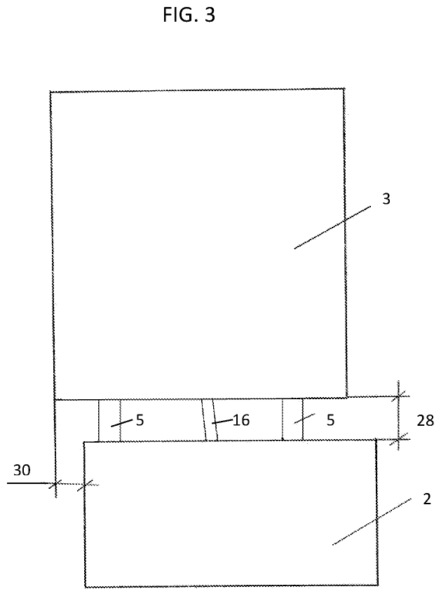

FIG. 3 presents the furniture with divided, adjustable lying surface where linear and lateral movement of one part of lying surface aids natural decompression of the spine of person lying in supine position with the optional, forced, lateral movement of the movable part of the furniture in a bird's eye view and shows directions of horizontal movement of movable segment (2) of lie (1) in relation to static segment (3) of lie (1), where longitudinal travel is marked as (28) and where lateral travel is marked as (30).

Drawing shows longitudinal elements (5), which are parts of load bearing frame (4) and flexible connecting element (16) connecting movable segment (2) of lie (1) with static segment (3) of lie (1),

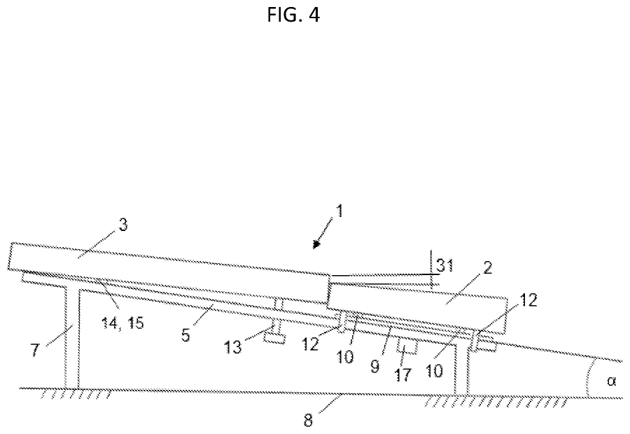

FIG. 4 presents the furniture with divided, adjustable lying surface where linear and lateral movement of one part of lying surface aids natural decompression of the spine of person lying in supine position with the optional, forced, lateral movement of the movable part of the furniture in the view from side in a user-prepared state for use. Section (2) of lie (1) and section (3) of lie (1) are adjacent. Difference in elevation between section (2) of lie (1) and lower part of section (3) of lie (1) is achieved by action of elevation adjusting bolts with knobs (13). Upper part of plywood backing of section (3) of lie (1) is connected to surface of element (5) of load bearing frame (4) with screw (14) with rubber spacer (15). Rubber spacer (15) enable change of angle between plywood backing of section (3) of lie (1) and surface of load bearing frame (4) during action of elevation adjusting bolts with knobs (13). Difference in elevation between section (2) of lie (1) and section (3) of lie (1) is indicated by (31). Holders (12) limit lateral movement of movable section (2) on lateral guiding rails (10). Motor (17) is attached to plywood backing of movable section (2). Full extension of the ground is omitted to save space.

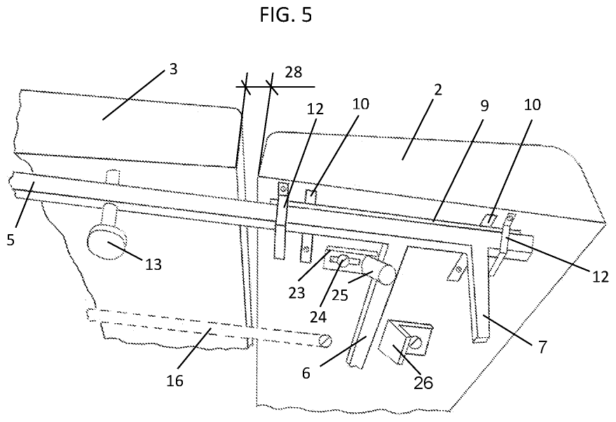

FIG. 5 presents the furniture with divided, adjustable lying surface where linear and lateral movement of one part of lying surface aids natural decompression of the spine of person lying in supine position with the optional, forced, lateral movement of the movable part of the furniture shown in an axonometric view during use where the movable segment (2) of lie (1) is detached from stationary segment (3) of lie (1). Maximal, longitudinal, downward movement of section (2) on longitudinal guiding rails (9) is limited by position of rollers (25). Position of rollers (25) is established by moving mounting plate with elongated slot (23) along its elongated slot and securing it in place with stationary holding screw (24).

Lateral, sideways movement of section (2), on lateral guiding rails (10) is limited by position of holders (12).

Magnetized, L-shaped plate (26) which holds section (2) of lie (1) adhered to section (3) of lie (1) in prepare to use state is now detached from element (6).

Flexible connecting element (16) is stretched.

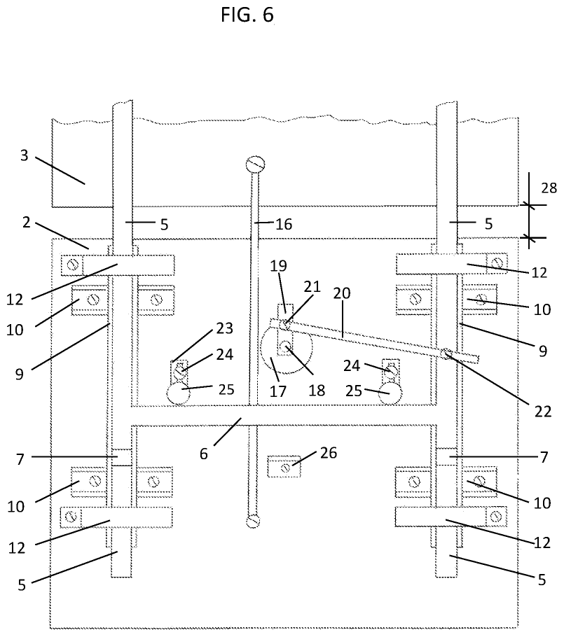

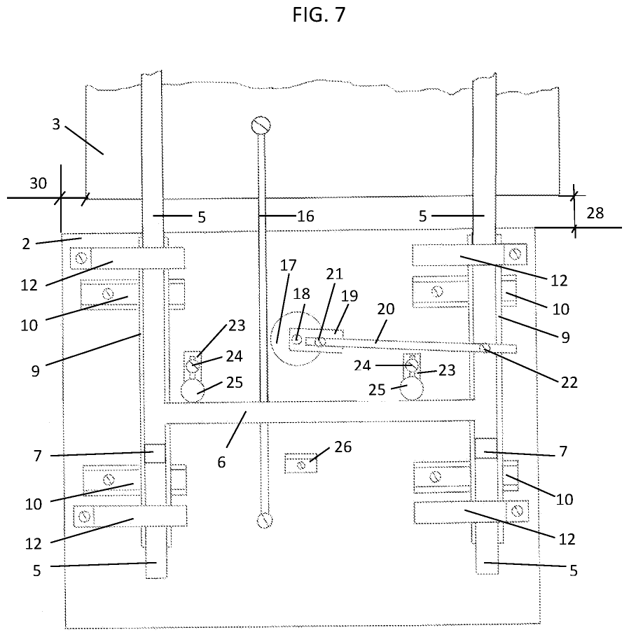

Detail drawings of attachment (17,18,19,20,21,22) which forces lateral movement of segment (2) of lie (1) is shown in FIG. 6/9 and FIG. 7/9.

FIG. 6 presents the furniture with divided, adjustable lying surface where linear and lateral movement of one part of lying surface aids natural decompression of the spine of person lying in supine position with the optional, forced, lateral movement of the movable part of the furniture and shows plywood backing site of movable segment (2) of lie (1) where crank (19) of motor (17), and shaft (18) of motor (17) are in central position in relation to longitudinal sides of movable segment (2) of lie (1). Neutral position of crank (19) centers longitudinally movable segment (2) of lie (1) with static segment (3) of lie (1). Drawing show section (2) of lie (1) at maximal, longitudinal downward extension (29) determined by position of rollers mounting plates with elongated slot (23) which dictate position of rollers (25).

FIG. 7 presents the furniture with divided, adjustable lying surface where linear and lateral movement of one part of lying surface aids natural decompression of the spine of person lying in supine position with the optional, forced, lateral movement of the movable part of the furniture and shows plywood backing site of movable segment (2) of lie (1) with movable segment (2) of lie (1) in lateral travel position (30) which extend is dictated by position of the hinge pin (21) on motor's (17) crank plate (19).

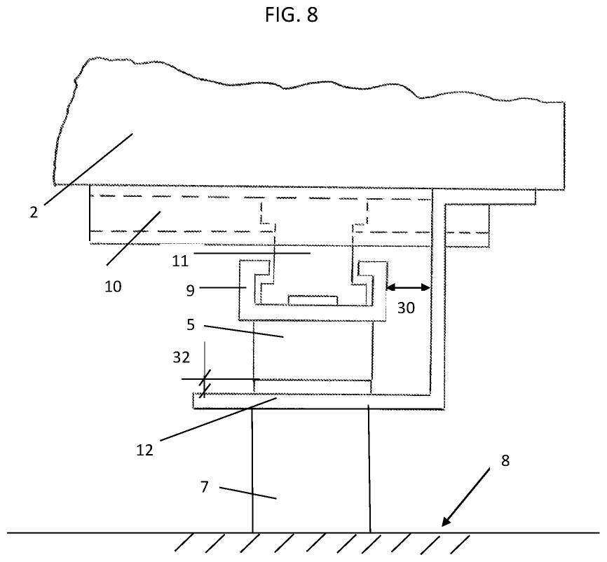

In free-floating set up, where rod (20) is disconnected from element (5) of load bearing frame (4) by pulling out latching hinge pin (22). This free lateral travel movement (30) is limited by positions of holders (12). FIG. 8/9.

FIG. 8 presents the furniture with divided, adjustable lying surface where linear and lateral movement of one part of lying surface aids natural decompression of the spine of person lying in supine position with the optional, forced, lateral movement of the movable part of the furniture and shows configuration of one of four guiding system (9,10,11) in a view from lower, right end of furniture. For clarity, detail drawings of attachment (17,18,19,20,21,22) which forces lateral movement of segment (2) of lie (1) shown in FIG. 6/9 and FIG. 7/9 are omitted.

Sliding element (11) is common with longitudinal guiding rail (9) and with lateral guiding rail (10) allowing movement of section (2) of lie (1) on the surface of load bearing frame (4) in both directions at the same time. Longitudinal guiding rail (9) is attached to element (5) of load bearing frame (4) and lateral guiding rail (10) is attached to plywood backing of section (2) of lie (1).

In this free-floating setup maximal lateral travel (30) of section (2) of lie (1) on lateral rail (10) is limited by position of holders (12). Space (32) between bottom of element (5) of load bearing frame (4) and holder (12) enable unobstructed by friction movement of section (2) of lie (1) on the surface of load bearing frame (4).

Maximal longitudinal travel of section (2) of lie (1) along rail (9) is limited by position of rollers (25). See FIG. 7/9.

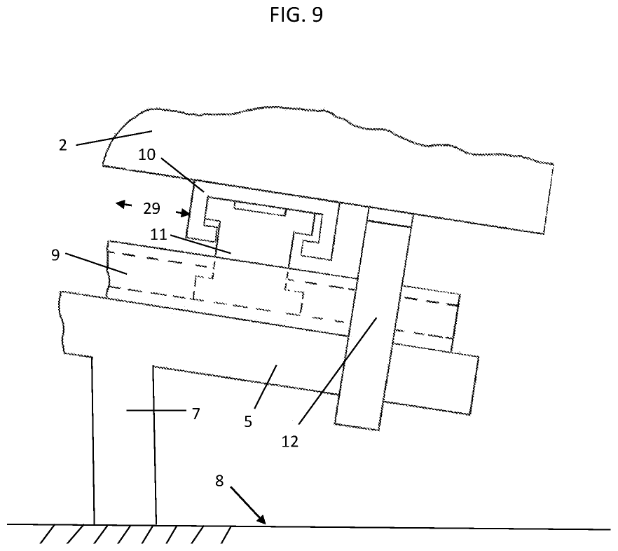

FIG. 9 presents the furniture with divided, adjustable lying surface where linear and lateral movement of one part of lying surface aids natural decompression of the spine of person lying in supine position with the optional, forced, lateral movement of the movable part of the furniture and shows configuration of one of four guiding systems (9,10,11) in a view from side of the furniture. For clarity, detail drawings of attachment (17,18,19,20,21,22) which forces lateral movement of segment (2) of lie (1) shown in FIG. 6/9 and FIG. 7/9 are omitted.

Sliding element (11) is common with longitudinal guiding rail (9) and with lateral guiding rail (10) allowing movement of section (2) of lie (1) on the surface of load bearing frame (4) in both directions at the same time. Longitudinal guiding rail (9) is attached to element (5) of load bearing frame (4) and lateral guiding rail (10) is attached to plywood backing of section (2) of lie (1).

Maximal longitudinal travel (29) of section (2) of lie (1) along rail (9) is limited by position of rollers (25). See FIG. 7/9.

### DETAILED DESCRIPTION OF THE INVENTION

The furniture with adjustable lying surface where movement of one part of lying surface aids natural decompression of lumbar section of human body is created from the lie 1 divided into two sections 2, 3, which are cushions with plywood backing for rigidity. (FIG. 4)

The lie 1 is placed on a stationary, made of square steel tubing, load-bearing frame 4 and elevated over its standing surface 8 by its supports 7. (FIG. 4)

The surface of load-bearing frame 4 consists of longitudinal elements 5 and lateral elements 6.

Longitudinal elements 5 are connected to lateral elements 6 at a 90-degree angle.

The upper surface of the stationary load-bearing frame 4 is tilted to the ground 8 at an α angle and ranges from 1 to 20 degrees. (FIG. 4)

The section 3 of lie 1 is stationary and is supported by longitudinal elements 5 of load bearing frame 4.

The upper part of section 3 of the lie 1 is attached to the longitudinal elements 5 of load bearing frame 4 with screws 14 equipped with at least 0.5 cm (0.125 inch) thick, flexible rubber spacer 15, which has a hole in the middle of its flat surface to accommodate a diameter of screw 14 which holds plywood backing of section 3 of the lie 1 and element 5 of frame 4 together.

The lower part of section 3 of lie 1 is attached to the longitudinal elements 5 of frame 4 by adjustment bolts with knobs 13 used to change elevation of the lower part of section 3 of lie 1.

Flexible rubber spacer 15 accommodates change of angle between plywood backing of section 3 of the lie 1 and the surface of load bearing frame 4 caused by action of elevation adjustment bolts with knobs 13.

The difference in elevation 31 between the surface of lower end of section 3 of lie 1 and the surface of upper end of section 2 of lie 1 is adjusted by elevation adjusting bolts with knobs 13 and is from 0 to 5 cm (0 to 2 inch). (FIG. 4)

The movable section 2 of lie 1 is shaped so its plywood backing surface is in parallel to the surface of load bearing frame 4 and the cushioned upper surface of section 2 of lie 1 is tilted to the upper surface of frame 4 at 10 deg. (FIG. 4)

To the longitudinal elements 5 of the load bearing frame 4 are attached longitudinal guiding rails 9 which enable movement of section 2 of the lie 1 on the surface of frame 4 in longitudinal direction. (FIG. 5)

To the plywood backing side of section 2 of the lie 1 are attached lateral guiding rails 10 which enable movement of section 2 of the lie 1 on the surface of frame 4 in lateral direction. (FIG. 5)

Guiding rails 9, 10 have common sliding element 11 that engages both rails 9, 10 what let section 2 of lie 1 to move in longitudinal and lateral directions. (FIG. 8)

Maximal lateral shift 30 of section 2 of lie 1 along lateral guiding rails 10 is restricted by position of holding elements 12 attached to plywood backing of section 2 of lie 1. (FIG. 5)

The rectangular shaped holding elements 12 embrace longitudinal elements 5 of frame 4.

There are spaces 32 between surface of holding elements 12 and surface of back sides of longitudinal elements 5.

Spaces 32 are 0.25 inch (0.6 cm).

Spaces 32 enable unobstructed by friction longitudinal and lateral movement of section 2 of lie 1 on surface of the load bearing frame 4. (FIG. 8)

Positions of holders 12 restrict maximal amplitude 30 of lateral movement of section 2 of lie 1 in free-floating setup of operation when there is no optional forced lateral movement device (17, 18, 19, 20, 21, 22) installed or the device (17, 18, 19, 20, 21, 22) is disconnected. (FIG. 7)

To the section 2 of lie 1, from the plywood backing side, are attached mounting plates 23 equipped with rollers 25 which aid the lateral movement of section 2 of lie 1 along element 6 of frame 4.

Mounting plates 23 have elongated slots trough which they are attached to plywood backing of section 2 of lie 1 by holding screws 24. (FIG. 7)

Repositioning of plates with elongated slots 23 in longitudinal direction and securing them in new positions with static holding screws 24 regulate the maximum allowed longitudinal travel 29 of section 2 of lie 1 along elements 5 of load bearing frame 4.

Both sections 2, 3 of lie 1, on plywood side are connected by a flexible connecting element 16. (FIG. 5)

Under no load condition flexible element 16 overcomes the weight of section 2 of lie 1 and pulls it toward section 3 of lie 1 making them adjacent.

To the Section 2 of lie 1, from plywood side, is attached permanently magnetized L-shaped angular plate 26. (FIG. 5)

When section 2 and section 3 of lie 1 are adjacent, due to action of flexible element 16, surface of the L-shaped angular plate 26 which is parallel to flat side of element 6 of the load bearing frame 4 adheres to the made of steel element 6 of the load bearing frame 4 and hold sections 2 and section 3 of lie 1 together.

User begins set up of the furniture with adjustable lying surface where movement of one part of lying surface aids natural decompression of the lumbar section of human body by adapting the shape of the lie 1 to anatomical shape of lumbar part of his body by turning two bolts with knobs 13 connecting the bottom of the section 3 of the lie 1 to the longitudinal element 5 of load bearing frame 4, thereby causing raising or lowering of the lower part of cushion of section 3 of the lie 1 above or flush with the upper part of cushion of section 2 of the lie 1. (FIG. 4)

The difference in elevation between the upper part of cushion of section 2 of the lie 1 and the lower part of cushion of section 3 of the lie 1 is adjusted depending on the so anatomical shape of the user's lumbar part of body and is regulated from 0 to 2.0 inch (0 to 5.0 cm). (FIG. 1)

User can adjust the maximum downward travel 29 of the section 2 of lie 1 from section 3 of lie 1 by repositioning of mounting plates 23 in longitudinal direction.

After setting up the vertical shape and longitudinal boundaries of free movement of section 2 of lie 1, user sits on the section 2 of lies 1, and lay down putting the upper part of this body on the section 3 of lie 1. (FIG. 1)

The head and upper part of user's trunk rests on section 3 of the lie 1, while the user's pelvis rests on section 2 of lie 1.

The lumbar part of the body is placed on the line of adhesion of section 3 of lie 1 and section 2 of lie 1.

User's knees are bent, and feet placed on the floor. (FIG. 1)

Lying down on the furniture user pushes downward the movable section 2 of lie 1 from stationary section 3 of lie 1.

The push downwards breaks the magnetic connection between the magnetic element 26 attached to movable section 2 of lie 1 and steel element 6 of load bearing frame 4. (FIG. 5)

Force of natural decompression of lumbar part of the body positioned in supine position aided by gravitational force exerted by pelvic weight on slanted lie 1 causes section 2 of lie 1 to overcome the resistance of the flexible connecting element 16 and slide down the load-bearing frame 4, on longitudinal guiding rails 9.

Lateral movement of section 2 of lie 1 on guiding rail 10 accommodates lateral shape of user's spine.

The gap 28 between the movable section 2 of lie 1 and the stationary section 3 of lie 1 is a measurement of degree of natural decompression of lumbar part of the body. (FIG. 5)

Laying down on the furniture the user can gradually increase the size of the gap 28 between section 3 of lie 1 and section 2 of lie 1 by pushing away section 2 of lie 1 with hands what moves section 3 of lie 1 further away from section 3 of lie 1.

This action pulls further apart user's pelvis area from user's upper torso further no stretching the lumbar zone of the body.

User's discomfort or overcoming of friction between fabric cowering cushions 2,3 of lie 1 and fabric of user's clothing limits the strength at which lumber zone of the body can be stretch.

Releasing manual pressure on section 2 of lie 1 by lifting user's pelvis above the surface of section 2 of lie 1 causes section 2 of lie 1 to pull up toward section 3 of lie 1, by attracting it by action of flexible connecting element 16.

Sections 2 and 3 of lie 1 are adjacent to each other and magnetic lock 26 engage.

User can comfortably leave the furniture. (FIG. 1)

Optional, forced lateral movement of section 2 of the lie 1 is achieved by low speed, adjustable, direct current electric motor 17 which is attached to the plywood backing of section 2 of the lie 1 in a position where the driving shaft 18 of the motor 17 is in perpendicular, downward position to the surface of plywood backing of section 2 of lie 1. (FIG. 6)

Driving shaft 18 is at equal distance from longitudinal edges of section 2 of lie 1.

Rotary movement of the driving shaft 18 of electric motor 17, through a crank mechanism 19, moves section 2 of the lie 1 in lateral direction in relation to the longitudinal elements 5 of the load-bearing frame 4 on lateral guide rails 10.

One end of crank's rod 20 is attached by a hinge pin 21 to a crank plate 19 on a motor's 17 driving shaft 18 and other end of a crank's rod 20 is attached by a latching hinge pin 22 to the longitudinal element 5 of the load bearing frame 4.

Crank 18 has premade holes to accommodate hinge pin 21.

The holes are situated at 0.5, 1.0, 2.0 and 2.5 cm (0.2, 0.4, 0.8 and 1.0 inches) from the center of motor shaft 18.

By changing a position of the hinge pin 21 on the crank 19, the amplitude 30 of movement of section 2 of the lie 1 in lateral direction in relation to the longitudinal element 5 of load bearing frame 4 is adjustable from 0.5 to 2.5 cm (0.2 to 1.0 inches), as per position of holes on the crank 19. (FIG. 7)

The maximum adjustment of the amplitude of movement of section 2 of the lie 1 in lateral direction in relation to the longitudinal element 5 of load bearing frame 4 is limited by position of holders 12.

The speed of movement of section 2 of the lie 1 in lateral direction in relation to the longitudinal element 5 of load bearing frame 4 is adjustable by DC motor's 17 speed controller from 0 to 20 rpm.

When installed, user has an option to use the forced lateral movement of section 2 of lie 1 by energizing of the motor 17 and controlling speed of lateral travel of section 2 of lie 1 with speed controller at amplitude 30 set by position of hinge pin 21 on crank 19.

When installed, user has an option not to use the forced lateral movement of section 2 of lie 1 by not energizing of the motor 17 what sets lateral travel 30 of section 2 of lie 1 to 0.0 cm (0.0 inches).

Movement of section 2 of lie 1 will be only in longitudinal direction.

When installed, user has an option to disengage the mechanism enabling forced lateral movement of section 2 of lie 1 by disconnected the crank's rod 20 from element 5 of frame 4 by pulling out the latching hinge pin 22.

Disconnecting the rod 20 from element 5 of frame 4 by pulling out the latching pin 22 enable free-floating of section 2 of lie 1 on the surface of load-bearing frame 4 within the boundaries defined by positions of rollers 25 and holding elements 12.

1. The furniture with divided, adjustable lying surface where movement of one part of lying surface, in linear and lateral directions, aids natural decompression of the spine of person lying in supine position, with the optional, forced, lateral movement of the movable part of the furniture formed from a lie (1) is divided into two sections (2,3) and placed on a stationary, load-bearing frame (4), where section (3) of the lie (1) is stationary to the load-bearing frame (4) and section (2) has ability to slide in longitudinal and lateral directions, using guiding device (9,10,11), along the longitudinal element (5) of frame (4), including, the upper surface of the stationary load-bearing frame (4) is inclined to the ground (8), while the lower part of the section (3) of lie (1) is attached to the stationary load-bearing frame (4) by means of adjusting screws with knobs (13) and both sections (2,3) of lie (1), on the load-bearing frame side (4), are connected by a flexible connecting element (16) and section (2) of lie (1) is fitted with rollers assembly (23,24,25).

2. The furniture with divided, adjustable lying surface where movement of one part of lying surface, in linear and lateral directions, aids natural decompression of the spine of person lying in supine position, with the optional forced, lateral movement of the movable part of the furniture according to the claim 1), is significant in that
the physical shape of lie (1) is created by adjusting position of section (3) of lie (1) in vertical direction in relation to the frame (4) and to the section (2) of lie (1).

3. The furniture with divided, adjustable lying surface where movement of one part of lying surface, in linear and lateral directions, aids natural decompression of the spine of person lying in supine position with the optional forced, lateral movement of the movable part of the furniture according to the claim 1), is significant in that
the section (2) of lie (1) has the ability to move on longitudinal guiding rails (9) of guiding devices (9,10,11) in longitudinal directions in relation to longitudinal element (5) of the load-bearing frame (4) and away from section (3) of lie (1), and is powered by force created by natural tendency of human body to decompress when body is placed in supine position and by user's weight of pelvic body area when user's body is placed in slanted position.

4. The furniture with divided, adjustable lying surface where movement of one part of lying surface, in linear and lateral directions, aids natural decompression of the spine of person lying in supine position with the optional forced, lateral movement of the movable part of the furniture according to the claim 1), is significant in that
the section (2) of lie (1) has the ability to move on the lateral rails (10) of guiding devices (9,10,11) in lateral directions in relation to the longitudinal element (5) of the load-bearing frame (4) and away from section (3) of lie (1), and is powered by force created by natural tendency of human body to decompress and the lateral shape of spine when body is placed in supine position and by user's weight of pelvic body area when user's body is placed in slanted position.

5. The furniture with divided, adjustable lying surface where movement of one part of lying surface, in linear and lateral directions, aids natural decompression of the spine of person lying in supine position with the optional, forced, lateral movement of the movable part of the furniture according to the claim 1), is significant in that
the guiding rails (9, 10) of guiding devices (9,10,11) use one common sliding element (11) what lets the section 2 of lie 1 to travel in longitudinal and lateral direction at the same time in distances exerted by natural decompression of user's spine.

6. The furniture with divided, adjustable lying surface where movement of one part of lying surface, in linear and lateral directions, aids natural decompression of the spine of person lying in supine position with the optional forced, lateral movement of the movable part of the furniture according to the claim 1), is significant in that
has the ability to force the lateral movement of section 2 of lie 1 within set boundaries (20,12) by motorized attachment (17, 18, 19, 20, 21, 22).
